(19) United States
(12) Patent Application Publication
(10) Pub. No.: US 2008/0183831 A1
(43) Pub. Date: Jul. 31, 2008

(54) METHOD, SYSTEM, MOBILE TERMINAL AND RI SERVER FOR WITHDRAWING RIGHTS OBJECT

(75) Inventors: Guoxin Shi, Shenzhen (CN); Yimin Li, Shenzhen (CN); Pei Dang, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/058,499

(22) Filed: Mar. 28, 2008

Related U.S. Application Data
(63) Continuation of application No. PCT/CN2006/002287, filed on Sep. 5, 2006.

(30) Foreign Application Priority Data
Sep. 28, 2005 (CN) 200510105248.5

(51) Int. Cl. G06F 15/16

(52) U.S. Cl. 709/206

(57) ABSTRACT

The present invention provides a method, system, mobile terminal and RI server for withdrawing a rights object. According to the method, mobile terminal sends a request message of withdrawing the rights object to a rights issuer; after receiving the request message of withdrawing the rights object, the rights issuer authenticates the mobile terminal, makes a withdrawing result according to the request message of withdrawing the rights object and a rights issuer rule, and sends a withdrawal status report message to the mobile terminal; the mobile terminal implements a process according a instruction content and sends a status report response message to the rights issuer after receiving the withdrawal status report message; and the rights issuer implements a process according to the status report response message. In embodiments of the present invention, through sending the request message of withdrawing the rights object, the mobile terminal or the rights issuer can withdraw the rights object which has been issued. The problem that the rights object can't be withdrawn in the prior art is solved.

### CROSS-REFERENCE TO RELATED APPLICATIONS

This application is a continuation of International Patent Application No. PCT/CN2006/002287, filed Sep. 5, 2006, which claims priority to Chinese Patent Application No. 200510105248.5, filed Sep. 28, 2005, entitled “Method, System, Mobile Terminal and RI Server for Withdrawing Rights Object,” commonly assigned, both are incorporated by reference herein for all purposes.

### FIELD OF THE INVENTION

The present invention relates to the field of Digital Rights Management (DRM), and more particularly to a method and system for withdrawing the Rights Object (RO) in DRM system.

### BACKGROUND OF THE INVENTION

DRM is a precondition of accomplishing a solution that digital information products having rights can be sold through the network. The digital rights protection technology can effectively avoid replicating, copying and using the digital information products illegally through the network and computers. A Content Issuer (CI) of the digital information products encrypts digital information and uploads it to the network. Users download the encrypted digital information to the Rights Agent (DRM Agent) in the terminal. The users need to request the RO of the digital information products from the Rights Issuer (RI) through the network if they want to use the downloaded digital information. The RO includes a secret key for decrypting data. If it is a one-off payment product, the users can use it after the DRM Agent decrypts the digital information by using the secret key. If it is needful to control the operating authority of the user, the RO should further include rights management information of the digital information. The DRM Agent performs management of the users on how to use the digital information specifically according to these restricting conditions. In the related art, the restrictions on the digital products generally include times of using, times of previewing, time restriction on each previewing, term of using and so on. Usually after completing the process of authenticating and registering between the terminals and the RI, the RI transmits the RO to the terminals.

Along with the development of mobile communication technology, more and more users start to use the mobile terminals to download digital information from the network. In the prior DRM protocol related to the mobile communication system, there is a series of protocols for acquiring the RO, but not any corresponding method for withdrawing the RO. Without the method for withdrawing the RO, the following several scenes can not be supported.

Scene 1, the user acquires two RO of a same content. For example, the user purchases a same content repeatedly; or the user buys by himself one RO of one content, the other one buys the RO of the same content and presents it to the user; or after buying one RO, the user wants to withdraw it. Under such circumstances the user has a demand to withdraw one RO through his own mobile terminal.

Scene 2, if some RO content which has been issued and purchased by users is found to be illegal or inappropriate to be used continually, it is needed to withdraw all of the ROs which have been issued so as to make the users unable to continue to use the content, or when the users in the scene 1 goes to the office to request the withdrawing of the RO which has been sent to his own terminal, the RI should have ability to initiate withdrawing the RO of the users.

### SUMMARY OF THE INVENTION

The present invention is to solve the problem that the rights object can not be withdrawn after it has been issued in the DRM system. The present invention provides methods, systems, a mobile terminal and RI server for withdrawing the rights object which are triggered by the mobile terminal or the RI after the rights issuer sends the rights object in the DRM system.

In order to accomplish the above object, the present invention provides a method for withdrawing rights object, which includes:

A0: a mobile terminal sends a request message of withdrawing the rights object to a rights issuer;

A1: the rights issuer certificates the mobile terminal, generates a withdrawing result according to the request message of withdrawing the rights object and a rights issuer rule, and sends a withdrawal status report message to the mobile terminal after receiving the request message of withdrawing the rights object;

A2: the mobile terminal receives the withdrawal status report message sent by the rights issuer, implements a process according to an instruction content in the withdrawal status report message and sends a status report response message to the rights issuer; and

A3: the rights issuer implements a process according to the status report response message.

The above method further includes that the rights issuer sends a trigger message to the mobile terminal prior to the step A0 and in the step A0, the mobile terminal sends the request message of withdrawing the rights object to the rights issuer after receiving the trigger message.

The trigger message in the above method includes a rights object identifier or a content identifier.

In the above method, the request message of withdrawing the rights object in the step A0 includes a rights object identifier, a content identifier or the rights object itself.

In the above method, the withdrawing result in the step A1 includes withdrawing the rights object or refusing the request of withdrawing.

In the above method, the withdrawal status report message in the step A1 sent by the rights issuer to the mobile terminal is signed by using a rights issuer certificate.

In the above method, the instruction content in the withdrawal status report message in the step A2 includes withdrawing successfully or withdrawing unsuccessfully. Delete the local rights object and prompt the user of withdrawing successfully when withdrawing successfully. Hold the local rights object and prompt the user of withdrawing unsuccessfully and the reason when withdrawing unsuccessfully.

In the step A3 of the above method, the step of the rights issuer implementing a process according to the status report response message includes the following steps:

when the rights issuer receives the response message, it implements a subsequent process; and

when the rights issuer does not receive the response message, it resumes the availability of the rights object which is ready to be withdrawn according to a withdrawing record and clears the set withdrawing record.

In order to accomplish the above object better, the present invention further provides a method for withdrawing the rights object, which includes:

B0: a rights issuer sends a request message of withdrawing the rights object to a mobile terminal;

B1: the mobile terminal deletes the local rights object requested to be withdrawn according to the request of the rights issuer, after it authenticates the rights issuer; and

B2: the mobile terminal sends a status report of withdrawing unsuccessfully to the rights issuer.

In the above method, the request message of withdrawing the rights object in the step B0 includes a rights object identifier, a content identifier or the rights object itself.

In the above method, the status report in the step B1 includes a rights object identifier, a result and reason of withdrawing.

In order to accomplish the above object better, the present invention further provides a system for withdrawing the rights object, which includes:

a mobile terminal, configured to generate a request message of withdrawing the rights object, implement a corresponding process and generate a status report response message according to a withdrawal status report message sent by the rights issuer; and

a rights issuer server, configured to make a withdrawing result according to the request message of withdrawing the rights object, generate the withdrawal status report message and implement a process according to the status report response message.

In order to accomplish the above object better, the present invention further provides a system for withdrawing the rights object, which includes:

a rights issuer server, configured to send a request message of withdrawing the rights object to a mobile terminal; and

the mobile terminal, configured to delete the local rights object which is requested to be withdrawn according to the request message of withdrawing the rights object sent by the rights issuer and send a status report of withdrawing successfully to the rights issuer.

In order to accomplish the above object better, the present invention further provides a mobile terminal for withdrawing the rights object, which includes:

an interface module, configured to send messages to a rights issuer server and receive messages from the rights issuer server;

a security module, configured to sign the messages sent to the rights issuer server and verify the messages received from the rights issuer server; and

a controlling module, configured to generate a request message of withdrawing the rights object, implement a corresponding process according to a withdrawal status report message sent by the rights issuer, and generate a status report response message, or configured to delete the local rights object which is requested to be withdrawn according to the request message of withdrawing the rights object sent by the rights issuer, and send a status report of withdrawing successfully to the rights issuer.

In order to accomplish the above object better, the present invention further provides a rights issuer server for withdrawing the rights object, which includes:

an interface module, configured to send messages to a mobile terminal and receive messages from the mobile terminal;

a security module, configured to sign the messages sent to the mobile terminal and verify the messages received from the mobile terminal; and

a controlling module, configured to make a withdrawing result according to a request message of withdrawing the rights object sent by the mobile terminal, generate the withdrawal status report message, and implement a process according to a status report response message; or configured to send the request message of withdrawing the rights object to the mobile terminal.

The methods, devices and systems of the present invention solve the problem that the rights object can not be withdrawn in the prior art in the way the mobile terminal or the rights issuer sends the request message of withdrawing the rights object after the rights object is issued, so as to enable the mobile terminal or the rights issuer to withdraw the rights object which has been issued.

### BRIEF DESCRIPTION OF THE DRAWINGS

FIG. 1 shows a flow chart of withdrawing the RO triggered by the mobile terminal according to embodiment 1 of the present invention;

FIG. 2 shows a flow chart of withdrawing the RO triggered by the RI according to embodiment 2 of the present invention;

FIG. 3 shows a system schematic diagram of the DRM according to an embodiment of the present invention; and

FIG. 4 shows a flow chart of withdrawing the RO triggered by the RI according to embodiment 3 of the present invention.

### DETAILED DESCRIPTION OF THE PREFERRED EMBODIMENTS

The present invention provides methods and systems for withdrawing an RO triggered by a mobile terminal or an RI after the RI sends the RO in the DRM system.

The method for withdrawing the RO triggered by the mobile terminal according to an embodiment of the present invention includes the following steps:

A0: the mobile terminal sends a request message of withdrawing the RO including a DRM device certificate to the RI, which includes a rights object identifier (ROID), a content identifier (ContentID) (which is used for instructing to withdraw the RO corresponding to the ROID or the RO corresponding to the ContentID), or the rights object needed to be withdrawn and so on;

A1: the RI sends an RO withdrawal status report message including the ROID/ContentID and carrying a withdrawing result to the mobile terminal; and

A2: the mobile terminal receives the RO withdrawal status report message, and after receiving the message, deletes the RO according to the instruction of the RI and sends a withdrawal report response message to the RI.

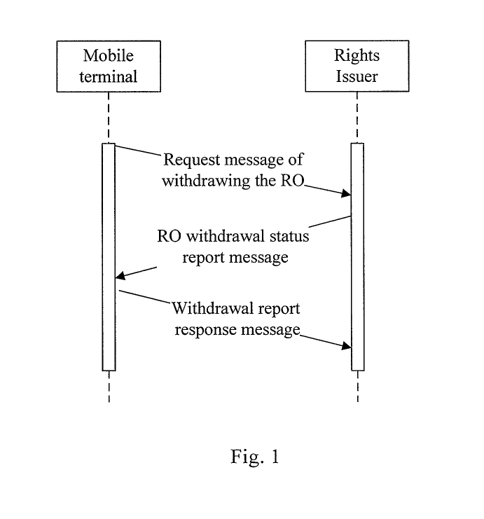

FIG. 1 shows a flow chart of withdrawing the RO triggered by the mobile terminal according to the embodiment 1 of the present invention. Referring to FIG. 1, it includes the following steps.

Step 1: the mobile terminal applies to the RI for withdrawing the RO and sends a request message of withdrawing the RO to the RI. The request of withdrawing may include the ROID, the ContentID or the RO itself or the like. The RO which is ready to be withdrawn is set to be unusable and is added into a pre-withdrawing record. When sending the request message of withdrawing the RO, the mobile terminal needs to sign the request of withdrawing by using the DRM device certificate so as to ensure its security;

Step 2: according to the request of withdrawing the RO sent by the mobile terminal, the RI withdraws the corresponding RO or refuses the request of withdrawing according to the request of the mobile terminal and the rule of the RI after authenticating the mobile terminal. The RI updates a local withdrawing record, then sends the status report of withdrawing successfully or unsuccessfully to the mobile terminal. The status report may include the ROID or ContentID and it may include a withdrawing result, reason and so on. When sending the status report, the RI needs to sign the status report by using the RI certificate to ensure its security; and

Step 3: after receiving the RO withdrawal status report message, the mobile terminal implements a corresponding process according to the content of the status report of withdrawing successfully or unsuccessfully. For example, when withdrawing successfully, the mobile terminal deletes the local RO and prompts the user of withdrawing successfully, and when withdrawing unsuccessfully, holds the local RO and prompts the user of withdrawing unsuccessfully and the reason. Then a status report response message is sent to inform the RI that the status report message has been received correctly. After receiving the response message, the RI implements a subsequent process, for example, completing a charging processing, clearing the local withdrawing record and so on. If the RI does not receive the response message, the RI needs to roll back according to the withdrawing record, namely to resume availability of the RO which is ready to be withdrawn and clear the set withdrawing record. When sending the response message, the mobile terminal needs to sign the response message by using the DRM device certificate to ensure its security.

The method of withdrawing the RO triggered by the RI includes the following steps:

B0: the RI sends the request message of withdrawing the RO including the RI certificate to the mobile terminal, which includes the ROID, the ContentID or the RO that is need to be withdrawn or the like; and

B1: the mobile terminal deletes the corresponding RO according to the instruction of the RI, and sends the withdrawal status report message to the RI, which includes the ROID or the ContentID, and carries the withdrawing result.

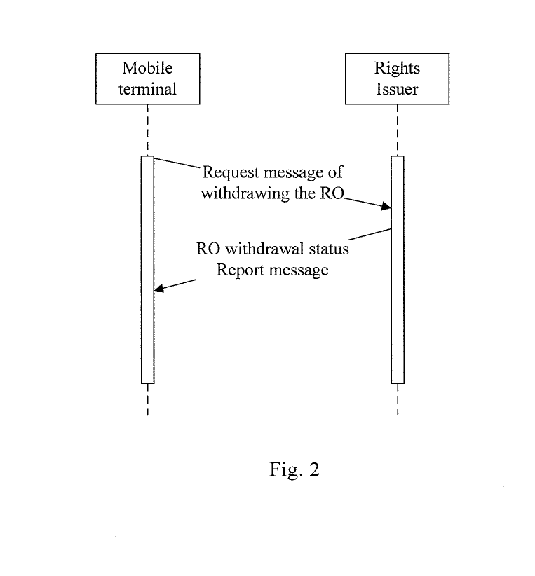

FIG. 2 is an information flow chart of withdrawing the RO triggered by the RI according to the embodiment 2 of the present invention. Referring to FIG. 2, it includes the following steps:

Step 1: the RI applies to the mobile terminal for withdrawing the RO, and sends a request of withdrawing the RO to the mobile terminal. The request of withdrawing includes the ROID, the ContentID, the RO itself or the like. When sending the request of withdrawing the RO, the RI needs to sign the request of withdrawing by using the RI certificate to ensure its security;

Step 2: according to the request of withdrawing the RO sent by the RI, after authenticating the RI, the mobile terminal withdraws the corresponding RO according to the request of the RI. The mobile terminal deletes the local RO which is requested to be withdrawn. The withdrawing result must be successful, namely the device can not refuse the request of withdrawing of the RI. Then the mobile terminal sends a status report of withdrawing successfully to the RI. The status report may include the ROID, the ContentID, the withdrawing result, the reason and so on. The reason can be described in detail as follows: the RO does not exist, or the rights have been exhausted, etc. When sending the status report, the mobile terminal needs to sign the status report by using the DRM device certificate to ensure its security.

The DRM system in the prior mobile communications field includes the Rights Agent (DRM Agent) set in the mobile terminal and the RI server connecting with the DRM Agent through the mobile communications network. The DRM Agent includes an agent interface module and an agent controlling module for receiving/sending messages. The RI server includes an RI interface module and an RI controlling module for receiving/sending messages.

In order to accomplish the method of the present invention, modules partition and function definition are needed to be implemented in DRM Agent and the RI server.

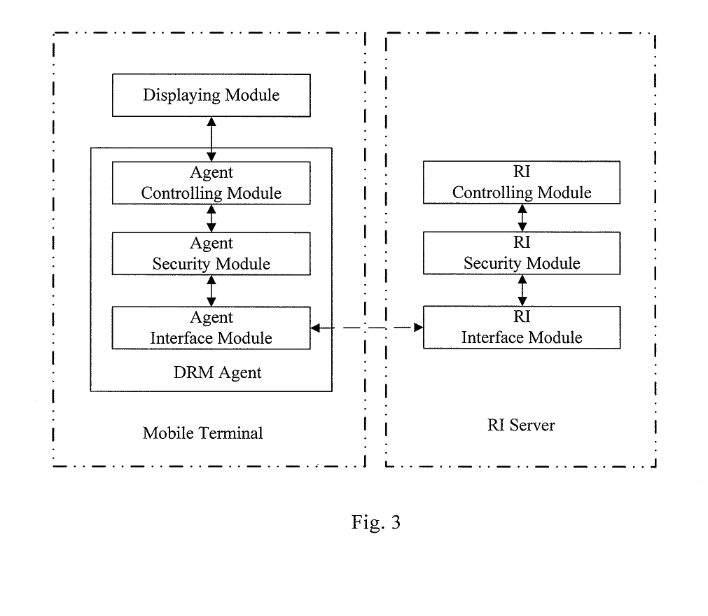

FIG. 3 shows a system schematic diagram of the DRM according to an embodiment of the present invention, which includes the following.

In the embodiment 1, all of the modules and their function in the scene of withdrawing the RO triggered by the mobile terminal are as follows:

the mobile terminal receives an instruction of withdrawing the RO applied by the user in the displaying module, generates the request message of withdrawing the RO in the controlling module, and sends it to the RI through the interface module after signing it by using the DRM device certificate in the security module. After the request message of withdrawing the RO of the DRM device is received by the RI interface module, it is processed through the security module, and is transferred to the RI controlling module. The RI controlling module checks a history record according to the request and adds a record to the pre-withdrawing record. The RO withdrawal status report message is generated by the controlling module and is sent to the mobile terminal through the RI interface module after it is signed by the security module by using the RI certificate. After the status report is received by the interface module of the mobile terminal, and through the security module, it is sent to the controlling module to be processed. The controlling module implements the corresponding process according to the content of the status report of withdrawing successfully or unsuccessfully. For example, when withdrawing successfully, the controlling module deletes the local RO and prompts the user of withdrawing successfully and so on, and when withdrawing unsuccessfully, holds the local RO and prompts the user of withdrawing unsuccessfully and the reason. Then the controlling module generates the status report response message. The status report response message is sent to the interface module of the mobile terminal after the security module signs the message by using the DRM device certificate, and the interface module of the mobile terminal sends it to the RI. After the status report response message is received by the RI interface module, it is transferred to the RI controlling module through the security module. Then the RI controlling module implements the subsequent process, completes the charging process, clears the local pre-withdrawing record, etc. If the RI does not receive the status report response message, it needs to roll back according to the withdrawing record.

In the embodiment 2, all of the modules and their functions in the scene of withdrawing the RO triggered by the RI are as follows:

the RI server accepts administrator's instruction of withdrawing the RO, generates the request message of withdrawing the RO in the control module, processes it in the security module, and sends it to the mobile terminal after signing it through the interface module by using the RI certificate. After the request message of withdrawing the RO issued from the RI is received by the interface module of the mobile terminal, it is processed by the security module and is transferred to the controlling module of the mobile terminal. After the controlling module searches the corresponding local RO, if the corresponding RO exists, it is marked as unusable and the withdrawal status report message of the RO is generated, and after it is signed by the security module by using the DRM device certificate, it is sent to the RI through the interface module. After the status report is received by the RI interface module, and through the security module, it is transferred to the RI controlling module to be processed, and the corresponding process is implemented and the administrator is prompted of the withdrawing successfully.

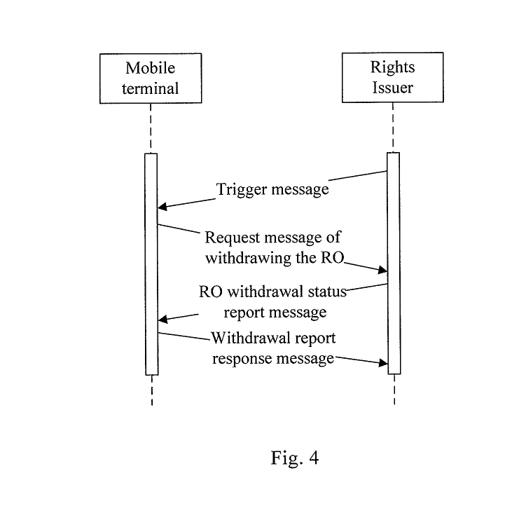

FIG. 4 is an information flow chart of withdrawing the RO triggered by the RI in embodiment 3 of the present invention. Referring to FIG. 4, it includes the following steps:

Step 1: the RI sends the trigger message to the mobile terminal, in which includes the ROID or the ContentID, requests the mobile terminal to initiate the flow of withdrawing the RO aiming at the ROID or the ContentID, and signs the trigger message by using the RI's certificate;

Step 2: the mobile terminal applies to the RI for withdrawing the RO and sends the request of withdrawing the RO to the RI. The request of withdrawing may include the ROID, the ContentID or the RO itself or the like. When sending the request of withdrawing the RO, the RI needs to sign the request of withdrawing by using the DRM device certificate to ensure its security;

Step 3: according to the request of withdrawing the RO sent by the mobile terminal, after the RI authenticates the mobile terminal, the RI withdraws the corresponding RO or refuses the request of withdrawing according to the request of the mobile terminal and the rule of the RI. When withdrawing successfully, the RI is needed to update the local withdrawing record. Then the RI sends the status report of withdrawing successfully or unsuccessfully to the mobile terminal. The status report may include the ROID, the ContentID, result and reason of withdrawing and the like. When sending the status report, the RI needs to sign the status report by using the RI certificate to ensure its security; and

Step 4: after receiving the RO withdrawal status report message, the mobile terminal implements the corresponding process according to the content of the status report of withdrawing successfully or unsuccessfully. For example, when withdrawing successfully, the mobile terminal deletes the local RO and prompts the user of withdrawing successfully, and when withdrawing unsuccessfully, holds the local RO and prompts the user of withdrawing unsuccessfully and the reason. Then the mobile terminal sends the status report response message to inform the RI that the status report message has been received correctly. After receiving the response message, the RI proceeds with the subsequent process, for example, completing a charge process, clearing the local withdrawing record, etc. The RI needs to roll back according to the withdrawing record if the RI does not receive the response message. When sending the response message, the mobile terminal needs to sign the response message by using the DRM device certificate to ensure its security.

In the embodiment 3, all of the modules and their functions in the scene of withdrawing the RO triggered by the RI are as follows:

the RI sends the trigger message including the ROID or the ContentID to the mobile terminal, and requests the mobile terminal to initiate the flow of withdrawing the RO aiming at the ROID or the ContentID. The trigger message is signed by using the RI's certificate. The triggering message sent by the RI is received by the interface module of the mobile terminal, and through the security module, it is sent to the controlling module to be processed. The corresponding request message of withdrawing the RO is generated by the controlling module according to the trigger message and is sent to the RI through the interface module after it is signed by the security module by using the DRM device certificate. After the request message of withdrawing the RO of the DRM device is received by the RI interface module, it is processed through the security module, and is transferred to the RI controlling module. The RI controlling module checks a history record according to the request and adds a record to the pre-withdrawing record. The RO withdrawal status report message is generated by the controlling module and is sent to the mobile terminal through the RI interface module after it is signed by the security module by using the RI certificate. After the status report is received by the interface module of the mobile terminal, and through the security module, it is sent to the controlling module to be processed. The controlling module implements the corresponding process according to the content of the status report of withdrawing successfully or unsuccessfully. For example, when withdrawing successfully, the controlling module deletes the local RO and prompts the user of withdrawing successfully and so on, and when withdrawing unsuccessfully, holds the local RO and prompts the user of withdrawing unsuccessfully and the reason. Then the controlling module generates the status report response message, and the status report response message is sent to the interface module of the mobile terminal after the security module signs the message by using the DRM device certificate, then the interface module of the mobile terminal sends it to the RI. After the status report response message is received by the RI interface module, it is transferred to the RI controlling module through the security module. Then the RI controlling module implements the subsequent process, completes the charging process, clears the local pre-withdrawing record, etc. If the RI does not receive the status report response message, it is needed to roll back according to the withdrawing record.

Though illustration and description of the present disclosure have been given with reference to preferred embodiments thereof, it should be appreciated by persons of ordinary skill in the art various changes in forms and details can be made without deviation from the spirit and the scope of this disclosure, which are defined by the appended claims.

What is claimed is:

1. A method for withdrawing rights object, comprising:
sending a request message of withdrawing a rights object (RO) to a rights issuer (RI) server;
receiving a withdrawal status report message from the RI server which includes a withdrawing status; and
determining whether to delete a local RO and send a status report response message to the RI server according to the withdrawing status in the withdrawal status report message.

2. The method according to claim 1, wherein the request message of withdrawing the RO comprises an RO identifier, a content identifier or the RO itself.

3. The method according to claim 1, wherein the method further comprises: receiving a trigger message from the RI server before sending the request message of withdrawing the RO.

4. The method according to claim 3, wherein the trigger message comprises an RO identifier or a content identifier.

5. The method according to claim 1, wherein the request message of withdrawing the RO or the status report response message sent to the RI server is signed by using a terminal certificate; or the withdrawal status report message sent from the RI server is signed by using an RI server certificate.

6. The method according to claim 1, wherein the determining whether to delete the local rights object and send a status report response message to the RI server according to the withdrawing status comprises:
deleting the local RO and sending the status report response message to the RI server if the withdrawal status is successful;
holding the local rights object if the withdrawal status is unsuccessful.

7. A method for withdrawing rights object, comprising:
receiving a request message of withdrawing an RO sent from a terminal;
generating a withdrawing status according to the request message of withdrawing the RO; and
sending a withdrawal status report message to the terminal which includes the withdrawing status.

8. The method according to claim 7, wherein the request message of withdrawing the RO comprises an RO identifier, a content identifier or the RO itself.

9. The method according to claim 7, wherein the method further comprises: sending a trigger message to the terminal before receiving the request message of withdrawing the RO.

10. The method according to claim 9, wherein the trigger message comprises an RO identifier or a content identifier.

11. The method according to claim 7, wherein the request message of withdrawing the RO is signed by using a terminal certificate; or the withdrawal status report message is signed by using an RI server certificate.

12. The method according to claim 7, wherein the method further comprises: completing a charging process and clearing a local withdrawing record if a status report response message sent from the terminal is received.

13. The method according to claim 7, wherein the method further comprises: resuming the availability of the RO which is ready to be withdrawn according to a withdrawing record, and clearing the set withdrawing record if a status report response message is not received.

14. A method for withdrawing rights object, comprising:
receiving a request message of withdrawing an RO sent from an RI server;
deleting the local RO requested to be withdrawn according to the request message; and
sending a status report of withdrawing process to the RI server.

15. The method according to claim 14, wherein the request message of withdrawing the RO is signed by using an RI server certificate; or the status report of withdrawing successfully is signed by using a terminal certificate.

16. The method according to claim 14, wherein the request message of withdrawing the RO comprises an RO identifier, a content identifier or the RO itself.

17. The method according to claim 14, wherein the status report comprises an RO identifier, a result or reason of withdrawing.

18. A method for withdrawing rights object, comprising:
sending a request message of withdrawing an RO to a terminal;
receiving a status report of withdrawing successfully from the terminal.

19. A terminal, comprising:
an interface module, configured to send messages to an RI server and receive messages from the RI server; and
a controlling module, configured to generate a request message of withdrawing an RO and send the request message to the RI server through the interface module, delete the local RO according to a withdrawal status report message sent from the RI server, and send a status report response message to the RI server through the interface module; or configured to delete the local RO requested to be withdrawn according to the request message of withdrawing the RO sent by the RI server, and send a status report of withdrawing successfully to RI server through the interface module.

20. The terminal according to claim 19, wherein the terminal further comprises: a security module, configured to sign the messages sent to the RI server and verify the messages received from the RI server.

21. An RI server, comprising:
an interface module, configured to send messages to a terminal and receive messages from the terminal;
a controlling module, configured to generate a withdrawing status and a withdrawal status report message according to a request message of withdrawing an RO sent from the terminals, and send the withdrawal status report message to the terminal through the interface module; or configured to send a request message of withdrawing an RO to the terminal through the interface module.

22. The RI server according to claim 21, wherein the RI server further comprises: a security module, configured to sign the messages sent to the terminal and verify the messages received from the terminal.
